(19) United States
(12) Patent Application Publication
(10) Pub. No.: US 2022/0250652 A1
(43) Pub. Date: Aug. 11, 2022

(54) VIRTUAL LANE METHODS AND SYSTEMS

(71) Applicant: GM GLOBAL TECHNOLOGY OPERATIONS LLC, Detroit, MI (US)

(72) Inventors: Mohammed H. Al Qizwini, Macomb, MI (US); David H. Clifford, Royal Oak, MI (US); Mason D. Gemar, Cedar Park, TX (US)

(73) Assignee: GM GLOBAL TECHNOLOGY OPERATIONS LLC, Detroit, MI (US)

(21) Appl. No.: 17/174,100

(22) Filed: Feb. 11, 2021

(51) Int. Cl. B60W 60/00; G06K 9/46; G06K 9/20; G06K 9/00; G09G 5/37; B60W 30/06; B60W 50/00

(52) U.S. Cl. CPC B60W 60/0016; G06K 9/4604; G06K 9/2054; G06K 9/00812; G06K 9/00825; B60W 2554/80; B60W 30/06; B60W 50/0097; G09G 2380/10; G09G 2354/00; B60W 2420/42; G09G 5/37

(57) ABSTRACT

A system and method are provided for controlling a vehicle. In one embodiment, a system includes: a sensor system configured to generate sensor data sensed from an environment of the vehicle; and a control module configured to, by a processor, predict parked vehicles within the scene of the environment, identify an outer edge associated with the parked vehicles, generate a virtual lane line based on the outer edge associated with the parked vehicles, and generate signal data based on the virtual lane line to at least one of display the virtual lane line within the scene and control the vehicle.

### TECHNICAL FIELD

This technical field generally relates to perception systems for vehicles, and more particularly, relates to methods and systems for providing virtual lane information in an image of an environment of a vehicle.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved operation of autonomous vehicles. For example, challenges occur when navigating residential roads or other areas with on-street parking, construction zones, and parking lots. Generally, these areas are not marked with lane markings and the autonomous vehicle is left to determine the lane based on the environment.

Accordingly, it is desirable to provide methods and systems for providing virtual lane markings. Other desirable features and characteristics of the herein described embodiments will become apparent from the subsequent detailed description and the appended claims, taken in conjunction with the accompanying drawings and the foregoing technical field and background.

### SUMMARY

In various embodiments, systems and methods are provided for controlling a vehicle. In one embodiment a system includes: a sensor system configured to generate sensor data sensed from an environment of the vehicle; and a control module configured to, by a processor, predict parked vehicles within the scene of the environment, identify an outer edge associated with the parked vehicles, generate a virtual lane line based on the outer edge associated with the parked vehicles, and generate signal data based on the virtual lane line to at least one of display the virtual lane line within the scene and control the vehicle.

In various embodiments, the sensor system includes one or more cameras of the vehicle.

In various embodiments, the sensor system includes a satellite system.

In various embodiments, the control module is configured to identify the parked vehicle with a bounding box, and wherein the control module identifies the outer edge based on the bounding box.

In various embodiments, the control module is configured to generate the virtual lane line by fitting a polynomial to the outer edges of the parked vehicles. In various embodiments, the control module is configured to generate the virtual lane line by using data points from a left lane line identified in the scene or a virtual lane center line from the scene.

In various embodiments, the control module is configured to identify one or more available parking spaces based on a comparison of the virtual lane line to map data. In various embodiments, the control module modifies the display signal to modify the display of the virtual lane line based on the one or more available parking spaces.

In various embodiments, the control module is configured to adapt predictions of actors within the scene based on the virtual lane line. In various embodiments, the control module is configured to modify map data to include the virtual lane line as a feature of the map.

A method for controlling a vehicle, comprising: receiving, by a processor, sensor data sensed from an environment of the vehicle; processing, by the processor, the sensor data to predict parked vehicles within a scene of the environment; identifying, by the processor, an outer edge associated with the parked vehicles; generating, by the processor, a virtual lane line based on the outer edge associated with the parked vehicles; and generating, by the processor, signal data based on the virtual lane line to at least one of display the virtual lane line within the scene and control the vehicle.

In various embodiments, the sensor data is received from one or more cameras of the vehicle.

In various embodiments, the sensor data is received from a satellite system.

In various embodiments, the method further includes identifying the parked vehicle with a bounding box, and wherein the identifying the outer edge is based on the bounding box.

In various embodiments, the method further includes generating the virtual lane line by fitting a polynomial to the outer edges of the parked vehicles.

In various embodiments, the method further includes generating the virtual lane line by using data points from a left lane line identified in the scene or a virtual lane center line from the scene.

In various embodiments, the method further includes identifying one or more available parking spaces based on a comparison of the virtual lane line to map data.

In various embodiments, the method further includes modifying the display signal to modify the display of the virtual lane line based on the one or more available parking spaces.

In various embodiments, the method further includes adapting predictions of actors within the scene based on the virtual lane line.

In various embodiments, the method further includes modifying map data to include the virtual lane line as a feature of the map.

### DESCRIPTION OF THE DRAWINGS

The exemplary embodiments will hereinafter be described in conjunction with the following drawing figures, wherein like numerals denote like elements, and wherein:

FIG. 1 is an illustration of a top perspective schematic view of a vehicle having a virtual lane system in accordance with various embodiments;

FIG. 2 is a functional block diagram illustrating a virtual lane system in accordance with various embodiments;

FIGS. 3A-3E are exemplary interfaces of the virtual lane system in accordance with various embodiments;

FIG. 4 is a dataflow diagram illustrating a control module of the virtual lane system in accordance with various embodiments; and

FIG. 5 is a flowchart illustrating a method of displaying virtual lane information in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that contains one or more executable software or firmware programs and associated data, a combinational logic circuit, and/or other suitable components that provide the described functionality.

Embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components, e.g., towing apparatus, indicators or telltales; and electrical components, e.g., integrated circuit components, memory elements, digital signal processing elements, logic elements, look-up tables, imaging systems and devices or the like, which may carry out a variety of functions under the control of one or more microprocessors or other control devices. In addition, those skilled in the art will appreciate that the herein described embodiments may be practiced in conjunction with any number of mechanical and/or electronic systems, and that the vehicle systems described herein are merely exemplary.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

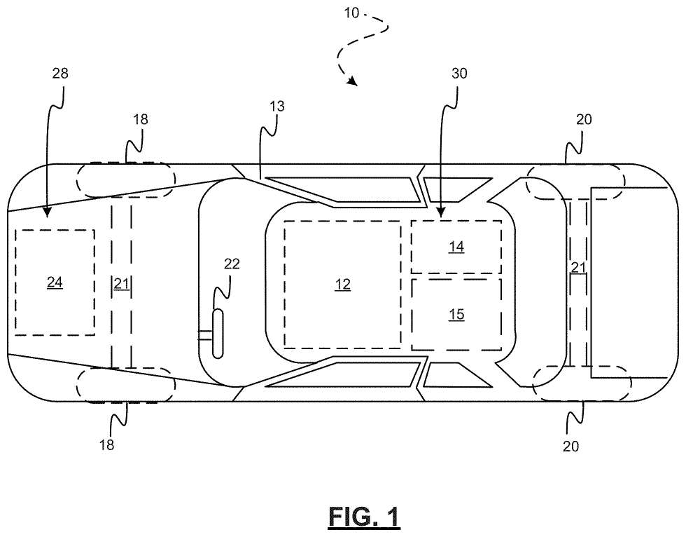

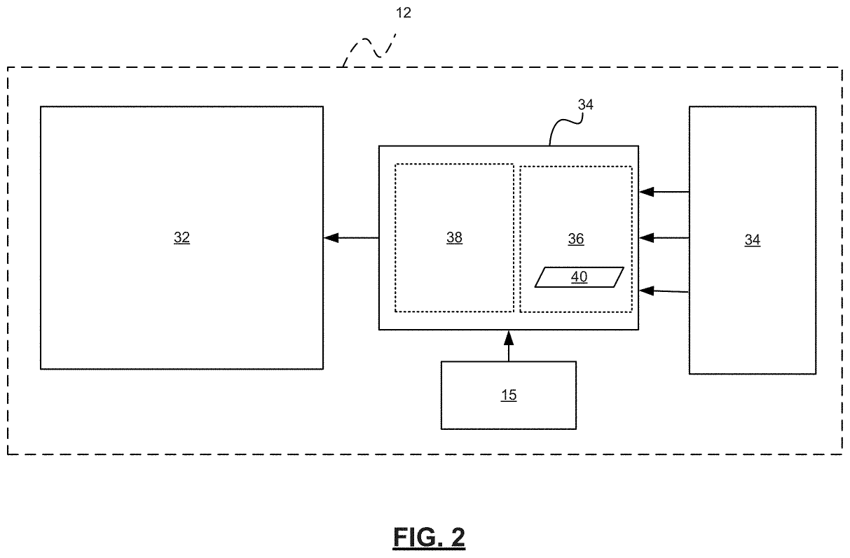

FIG. 1 is an illustration of a top view of a vehicle shown generally at 10 equipped with a virtual lane system shown generally at 12 in accordance with various embodiments. As will be discussed in more detail below, the virtual lane system 12 generally uses data from a sensor system 14 of the vehicle 10 and/or satellite/aerial imagery to predict virtual lane markings on roads such as, but not limited to, residential and city roads, parking areas, and construction zones. In such examples, a display screen 16 (FIG. 2) can be placed in any location of the vehicle 10 and can display images and/or videos that display a virtual lane markings on an image or video of an environment of the vehicle 10, for example, as if the lane markings were a part of the road.

Although the context of the discussion herein is with respect to the vehicle 10 being a passenger car, it should be understood that the teachings herein are compatible with all types of vehicles including, but not limited to, sedans, coupes, sport utility vehicles, pickup trucks, minivans, full-size vans, trucks, and buses as well as any type of towed vehicle such as a trailer.

As shown in the example of FIG. 1, the vehicle 10 generally includes a body 13, front wheels 18, rear wheels 20, a suspension system 21, a steering system 22, and a propulsion system 24. The wheels 18-20 are each rotationally coupled to the vehicle 10 near a respective corner of the body 13. The wheels 18-20 are coupled to the body 13 via the suspension system 21. The wheels 18 and/or 20 are driven by the propulsion system 24. The wheels 18 are steerable by the steering system 22.

The body 13 is arranged on or integrated with a chassis (not shown) and substantially encloses the components of the vehicle 10. The body 13 is configured to separate a powertrain compartment 28 (that includes at least the propulsion system 24) from a passenger compartment 30 that includes, among other features, seating (not shown) for one or more occupants of the vehicle 10. As used herein, the components “underneath” the vehicle 10 are components disposed below the body 13, such as, but not limited to, the wheels 18 and 20 (including their respective tires), and the suspension system 21.

The vehicle 10 further includes a sensor system 14 and an operator selection device 15. The sensor system 14 includes one or more sensing devices that sense observable conditions of components of the vehicle 10 and/or that sense observable conditions of the exterior environment of the vehicle 10. The sensing devices can include, but are not limited to, radars, lidars, global positioning systems, optical cameras, thermal cameras, ultrasonic sensors, height sensors, pressure sensors, steering angle sensors, and/or other sensors. The operator selection device 15 includes one or more user manipulable devices that can be manipulated by a user in order to provide input. The input can relate to, for example, activation of the display of virtual reality content and a desired viewing angle of the content to be displayed. The operator selection device 15 can include a knob, a switch, a touch screen, a voice recognition module, etc.

As shown in more detail in FIG. 2 and with continued reference to FIG. 1, the virtual lane system 12 includes a display screen 32 communicatively coupled to a control module 34. The control module 34 is communicatively coupled to the sensor system 14 and the operator selection device 15.

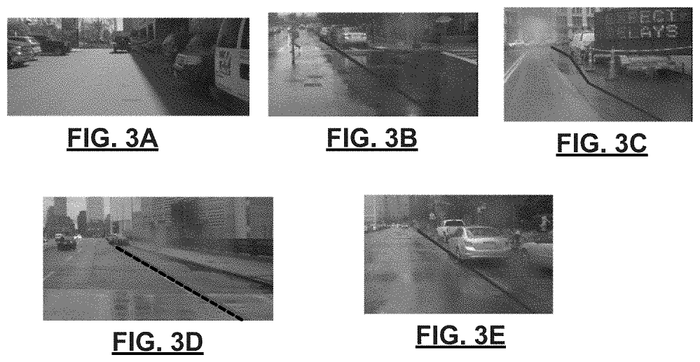

The display screen 32 may be disposed within the passenger compartment 30 at a location that enables viewing by an occupant of the vehicle 10. For example, the display screen 32 may integrated with an infotainment system (not shown) or instrument panel (not shown) of the vehicle 10. The display screen 32 displays content such that a partial virtual reality is experienced by the viewer. For example, as shown in FIG. 3, in various embodiments, the content 42 includes a depiction of a scene 48 the vehicle 10 is traveling, including the ground, curbs, road markings, buildings, other vehicles, pedestrians etc., as well as the virtual lane marking determined by the virtual lane systems and methods described herein.

For example, as shown in FIGS. 3A-3E, scenes of the environment are produced from sensor data obtained from one or more sensors of the vehicle 10. Thereafter, a virtual lane marking is determined and overlayed on the scene to illustrate a virtual lane. In various embodiments, as shown in FIG. 3A, the virtual lane markings identify a parking lane of a parking lot. In various embodiments, as shown in FIG. 3B, the virtual lane markings identify a lane through an intersection. In various embodiments, as shown in FIG. 3C, the virtual lane markings identify a lane around a parking zone. In various embodiments, as shown in FIG. 3D, the virtual lane markings identify available parking along a parking lane. In various embodiments, as shown in FIG. 3E, the virtual lane markings identify a lane around double parked cars. In various embodiments, the virtual lane markings can be displayed as a solid or dashed line having a particular color, highlight, or pattern that identifies the lane type or features.

With reference back to FIG. 2, the control module 34 may be dedicated to the display screen 32, may control the display screen 32 and other features of the vehicle 10 (e.g., a body control module, an instrument control module, or other feature control module), and/or may be implemented as a combination of control modules that control the display screen 32 and other features of the vehicle 10. For exemplary purposes, the control module 34 will be discussed and illustrated as a single control module associated with the display screen 32. The control module 34 may control the display screen 32 directly and/or communicates data to the display screen 32 such that scene and virtual lane content can be displayed.

The control module 34 includes at least memory 36 and a processor 38. As will be discussed in more detail below, the control module 34 includes instructions that when processed by the processor 38 control the content to be displayed on the display screen 32 based on sensor data received from the sensor system 14 and user input received from the operator selection device 15.

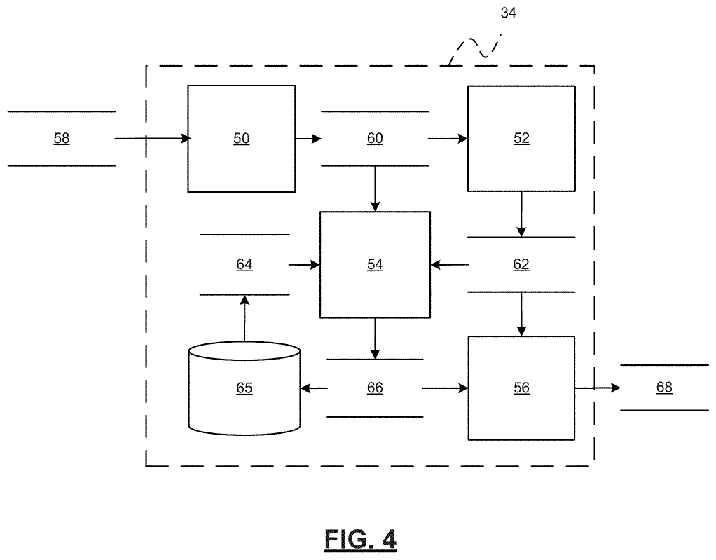

Referring now to FIG. 4 and with continued reference to FIG. 1-3, a dataflow diagram illustrates various embodiments of the control module 34 in greater detail. Various embodiments of the control module 34 according to the present disclosure may include any number of sub-modules. As can be appreciated, the sub-modules shown in FIG. 4 may be combined and/or further partitioned to similarly generate virtual reality content to be viewed by an operator. Inputs to the control module 34 may be received from the sensor system 14, received from the operator selection device 15, received from other control modules (not shown) of the vehicle 10, and/or determined by other sub-modules (not shown) of the control module 34. In various embodiments, the control module 34 includes a parked vehicle determination module 50, a feature extraction module 52, map feature determination module 54, and a display/control module 56.

In various embodiments, the parked vehicle determination module 50 receives image data 58. The image data 58 may be generated by, for example, one or more of the sensors of the sensor system 14 and/or generated by, for example, a satellite system associated with the vehicle. The parked vehicle determination module 50 processes the image data 58 to determine vehicles in the scene that are parked.

For example, a trained deep neural network can be used to predict that a vehicle is parked within the scene. As can be appreciated, various methods can be used to identify a vehicle and determine the status of the vehicle to be parked. The methods can be dependent on whether the image data 58 includes a ground view or an aerial view. Embodiments of the disclosure are not limited to any one example. In various embodiments, the parked vehicle determination module 50 tags each vehicle identified as parked with a bounding box around the identified vehicle within the scene. The parked vehicle determination module 50 provides parked vehicle data 60 based on the bounding boxes.

In various embodiments, the feature extraction module 52 receives the parked vehicle data 60 identifying the parked vehicles in the scene. The feature extraction module processes the parked vehicle data 60 to define an outer line of the identified parked vehicles. For example, the feature extraction module 52 identifies an outer edge of each of the bounding boxes and fits the outer edges with a smooth polynomial to generate a virtual line to represent an outer edge of a parking lane.

In various embodiments, the feature extraction module 52 further smooths the virtual lane line by using a lane line from the scene or a virtual center line in the scene as an additional data point when drawing the polynomial to ensure smoothness relative to road geometry. As can be appreciated, other methods of smoothing the line can be implemented in various embodiments. The feature extraction module 52 virtual lane line data 62 based on the smoothed virtual line.

In various embodiments, the map feature determination module 54 receives the parked vehicle data 60 and the virtual lane line data 62. The map feature determination module 54 compares the virtual lane line data 62 and the parked vehicle data 60 to map data 64 stored in a map data datastore 65. The map data 64 identifies a navigable map of the environment.

In various embodiments, based on the comparison, the map feature determination module 54 updates the map data datastore 65 to include the virtual lane line as a map feature by providing map feature data 66. In various embodiments, based on a comparison, the map feature determination module 54 identifies parking spaces adjacent to the virtual lane line that are available for parking. The map feature determination module 54 modifies the virtual lane line data 62 (e.g., the color, shading, highlighting, etc.) to identify the locations along the virtual lane line that have available parking and provides map feature data 66 based thereon.

In various embodiments, the display/control module 56 receives as input the virtual lane data 62, and the map feature data 66. The display/control module 56 generates signal data 68 to display the virtual lane lines and/or map features including available parking spaces with respect to the scene provided by the image data 58 to, for example, an occupant of the vehicle 10 via the display screen 32. The display/control module 56 generates the signal data 68 to control one or more features of the vehicle 10. For example, the virtual lane line data 62 can be used to append the lane polynomial to other lanes predicted by a perception model. In another example, the virtual lane line data 62 can be used to improve the detection of actions from vehicles/pedestrians around the virtual parking lane, and/or to control a path or route of the vehicle 10. As can be appreciated, the virtual lane line data 62 and/or the map feature data 66 can be used to control the vehicle 10 in various ways and is not limited to the present examples.

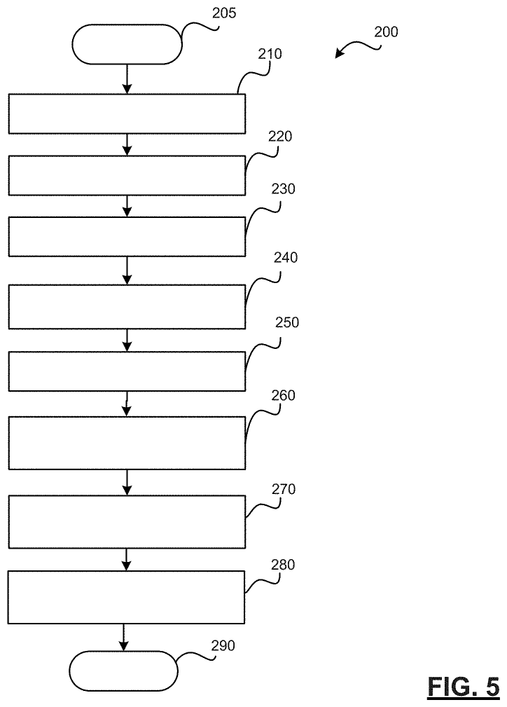

Referring now to FIG. 5, and with continued reference to FIGS. 1-4 a flowchart illustrates a method 200 that can be performed by the virtual lane system 12 in accordance with various embodiments. As can be appreciated in light of the disclosure, the order of operation within the method 200 is not limited to the sequential execution as illustrated in FIG. 5 but may be performed in one or more varying orders as applicable and in accordance with the present disclosure. As can further be appreciated, the methods 200 may be scheduled to run at predetermined time intervals during operation of the vehicle 10 and/or may be scheduled to run based on predetermined events.

In one example, the method may begin at 205. The image data is received at 210 and parked vehicles within the scene are identified and marked with bounding boxes at 220. The bounding boxes within the scene are evaluated to extract outer lines, for example, as discussed above at 230. The outer lines are then fit with a smooth polynomial to generate a lane line at 240. Optionally, the lane line can be enhanced using another identified lane marking (e.g., a virtual center lane line, left lane line, etc.) as an additional data point when fitting the polynomial at 250. Additionally, the other lane lines can be used with the virtual lane lines to construct a vehicle nominal path that ensures the vehicle will not encroach into other lanes as it adjusts its path to accommodate the adjacent parked cars or other obstructions separated by the virtual lane lines. Thereafter, the virtual lane line may be evaluated with map data to determine available parking spaces at 260. The virtual lane line and available parking spaces are the displayed to a user at 270, and used by other systems to update map information, predict actions of other actors within the scene, and/or control operation of the vehicle at 280. Thereafter, the method may end at 290.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for controlling a vehicle, comprising:
a sensor system configured to generate sensor data sensed from an environment of the vehicle; and
a control module configured to, by a processor, predict parked vehicles within the scene of the environment, identify an outer edge associated with the parked vehicles, generate a virtual lane line based on the outer edge associated with the parked vehicles, and generate signal data based on the virtual lane line to at least one of display the virtual lane line within the scene and control the vehicle.

2. The system of claim 1, wherein the sensor system includes one or more cameras of the vehicle.

3. The system of claim 1, wherein the sensor system includes a satellite system.

4. The system of claim 1, wherein the control module is configured to identify the parked vehicle with a bounding box, and wherein the control module identifies the outer edge based on the bounding box.

5. The system of claim 1, wherein the control module is configured to generate the virtual lane line by fitting a polynomial to the outer edges of the parked vehicles.

6. The system of claim 5, wherein the control module is configured to generate the virtual lane line by using data points from a left lane line identified in the scene or a virtual lane center line from the scene.

7. The system of claim 1, wherein the control module is configured to identify one or more available parking spaces based on a comparison of the virtual lane line to map data.

8. The system of claim 7, wherein the control module modifies the display signal to modify the display of the virtual lane line based on the one or more available parking spaces.

9. The system of claim 1, wherein the control module is configured to adapt predictions of actors within the scene based on the virtual lane line.

10. The system or claim 1, wherein the control module is configured to modify map data to include the virtual lane line as a feature of the map.

11. A method for controlling a vehicle, comprising:
receiving, by a processor, sensor data sensed from an environment of the vehicle;
processing, by the processor, the sensor data to predict parked vehicles within a scene of the environment;
identifying, by the processor, an outer edge associated with the parked vehicles;
generating, by the processor, a virtual lane line based on the outer edge associated with the parked vehicles; and
generating, by the processor, signal data based on the virtual lane line to at least one of display the virtual lane line within the scene and control the vehicle.

12. The method of claim 11, wherein the sensor data is received from one or more cameras of the vehicle.

13. The method of claim 11, wherein the sensor data is received from a satellite system.

14. The method of claim 11, further comprising identifying the parked vehicle with a bounding box, and wherein the identifying the outer edge is based on the bounding box.

15. The method of claim 11, further comprising generating the virtual lane line by fitting a polynomial to the outer edges of the parked vehicles.

16. The method of claim 15, further comprising generating the virtual lane line by using data points from a left lane line identified in the scene or a virtual lane center line from the scene.

17. The method of claim 11, further comprising identifying one or more available parking spaces based on a comparison of the virtual lane line to map data.

18. The method of claim 17, further comprising modifying the display signal to modify the display of the virtual lane line based on the one or more available parking spaces.

19. The method of claim 11, further comprising adapting predictions of actors within the scene based on the virtual lane line.

20. The method of claim 11, further comprising modifying map data to include the virtual lane line as a feature of the map.
